(19) United States
(12) Patent Application Publication
(10) Pub. No.: US 2012/0297997 A1
(43) Pub. Date: Nov. 29, 2012

(54) IMAGE FORMING APPARATUSES AND METHODS THEREOF

(76) Inventors: Michael Novick, San Diego, CA (US); David Luis Pereira, San Diego, CA (US); Geoffrey Schmid, San Diego, CA (US)

(21) Appl. No.: 13/115,142

(22) Filed: May 25, 2011

(51) Int. Cl. B41K 1/38; B41F 33/00

(52) U.S. Cl. 101/327; 101/483

(57) ABSTRACT

Image forming apparatuses and methods are disclosed. Image forming apparatuses and methods include a plate member including an upper plate surface to receive media on which to form images, an ink absorber member to receive ink in a form of ink build-up, and a blotter unit to periodically contact and press at least a portion of the ink build-up formed on the ink absorber member therein.

### BACKGROUND

Image forming apparatuses provide ink to media to form images thereon. Image forming apparatuses may include plate members and a plate receiver member. The plate receiver member may sequentially receive the plate members and ink build-up due to an overspray of ink directed toward media. The plate members such as platens may receive and support media on which images are to be formed.

### BRIEF DESCRIPTION OF THE DRAWINGS

Non-limiting examples are described in the following description, read with reference to the figures attached hereto and do not limit the scope of the claims. Dimensions of components and features illustrated in the figures are chosen primarily for convenience and clarity of presentation and are not necessarily to scale. Referring to the attached figures:

FIG. 1 is a block diagram of an image forming apparatus according to an example.

FIG. 2 is a perspective view illustrating a plate member of an image forming apparatus according to an example.

FIG. 3 is a perspective view illustrating an ink absorber member of an image forming apparatus according to an example.

FIG. 4A is a perspective view illustrating a blotter unit of an image forming apparatus according to an example.

FIG. 4B is a bottom view illustrating the blotter unit of FIG. 4A according to an example.

FIG. 5A is a perspective view illustrating a plate receiver member of an image forming apparatus according to an example.

FIG. 5B is a perspective view illustrating the plate receiver member of FIG. 5A and the ink absorber member of FIG. 3A in an inserted state of an image forming apparatus according to an example.

FIG. 6 is a schematic view illustrating a shuttle transport unit of an image forming apparatus according to an example.

FIG. 7A is a perspective view illustrating a plate member having media thereon, an ink absorber member, and a plate receiver member in a loaded state of an image forming apparatus according to an example.

FIG. 7B is a perspective view illustrating a blotter unit, an ink absorber member, and a plate receiver member in a loaded state of an image forming apparatus according to an example.

FIG. 7C is a cross-sectional view taken along line 7C-7C of the blotter unit, the ink absorber member, and the plate receiver member in the loaded state of FIG. 7B according to an example.

FIG. 8 is a perspective view of an ink absorber member of an image forming apparatus according to an example.

FIG. 9 is a flowchart illustrating a method of blotting ink build-up on in image forming apparatus according to an example.

### DETAILED DESCRIPTION

Image forming apparatuses include ink applicator units to provide ink to media to form images thereon such as in printing borderless prints such as photographs. Borderless prints are prints with no unprinted margin at the edge of the media. Image forming apparatuses may include plate members to receive and support media of various sizes such as four by six inches, five by seven inches, eight and a half by eleven inches, and the like, on which images are formed. The plate members may be sequentially received by a plate receiver member, for example, to be transported through various stages by a shuttle transport unit. Some of the ink provided by the ink applicator unit may accumulate on an ink absorber member in a form of ink build-up such as stalagmites due to ink overspray, particularly with pigment-based inks. Overtime, such ink build-up may increase in height and undesirably transfer to the back of plate members, media and/or on the ink applicator unit. The ink build-up and/or portions thereof may be further transferred to components of the image forming apparatus. Consequently, the lifespan of the respective components and/or image forming apparatus may be reduced and image quality defects may increase.

In examples, an image forming apparatus includes, among other things, a plate member including an upper plate surface to receive media on which to form images, an ink absorber member, an ink applicator unit to apply ink onto the media to form images thereon and the ink absorber member to form ink build-up thereon, and a blotter unit to periodically contact and press at least a portion of the ink build-up formed on the ink absorber member therein. Accordingly, a height of the ink build-up is reduced as well as its ability to undesirably transfer to the back of the plate members, the media, the ink applicator unit and/or additional components of the image forming apparatus. Accordingly, the potential reduction of the lifespan of the respective components and/or image forming apparatus and image quality defects are reduced. Further, the periodic pressing of the ink build-up into the ink absorber member may also increase the lifespan of the ink absorber member.

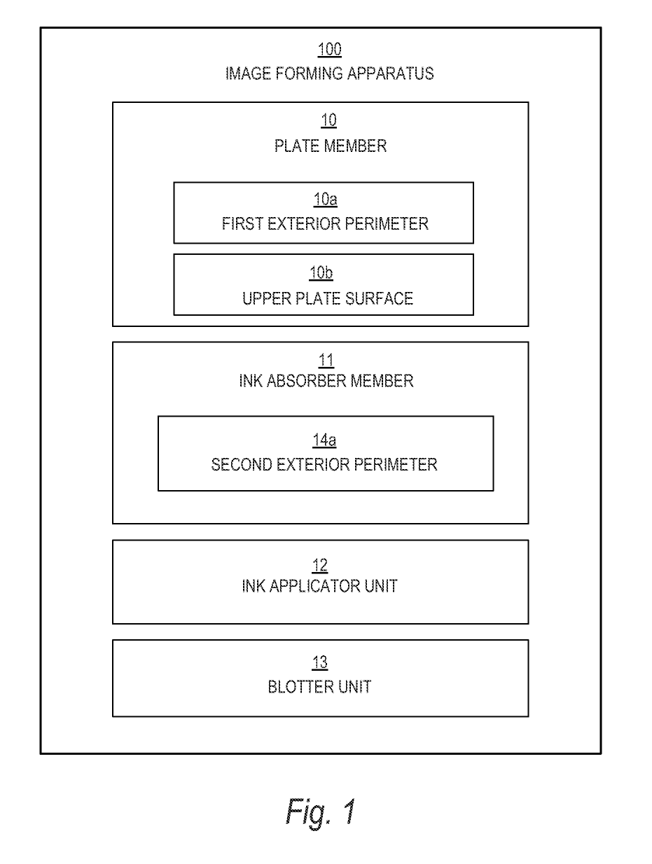

FIG. 1 is a block diagram illustrating an image forming apparatus according to an example. Referring to FIG. 1, in the present example, an image forming apparatus 100 includes a plate member 10, an ink absorber member 11, an ink applicator unit 12 and a blotter unit 13. The plate member 10 includes a first exterior perimeter 10a and an upper plate surface 10b to receive media on which to form images. The ink absorber member 11 includes a second exterior perimeter 14a. The ink applicator unit 12 may apply ink onto the media to form images thereon and the ink absorber member 11 to form ink build-up thereon. The blotter unit 13 may periodically contact and press at least a portion of the ink build-up formed on the ink absorber member 11 therein.

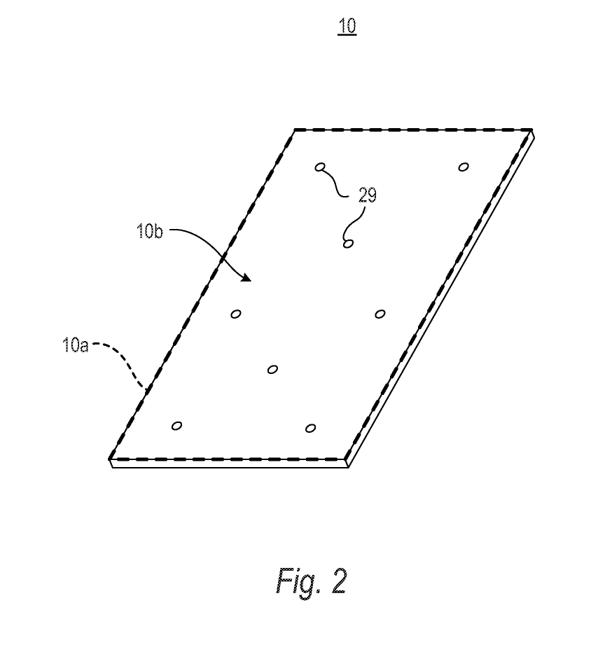

FIG. 2 is a perspective view illustrating a plate member of an image forming apparatus according to an example. Referring to FIG. 2, in examples, the plate member 10 includes an upper plate surface 10b to receive media on which to form images and a first exterior perimeter 10a. In examples, a size and shape of the upper plate surface 10b may correspond approximately to a size and shape of the media to be received. In the present example, the shape of the upper plate surface 10b may be rectangular and the size of the upper plate surface 10b may be slightly smaller than the media to be received to limit ink overspray from dribbling down the side of the plate member 10. For example, a respective media may extend beyond the upper plate surface 10b by one eight of an inch on each side. That is, the plate member 10 and its upper plate surface 10b may be 3.875 by 5.875 inches to receive a 4 by 6 inch media. In examples, the image forming apparatus 100 may include a plurality of plate members to receive media of a predetermined size and a plurality of blotter units. For example, each plate member 10 may receive a different-size media.

In examples, the first exterior perimeter 10a of the plate member 10 may be smaller than the second exterior perimeter 14a of the ink absorber member 11. Thus, the plate member 10 and the respective media disposed thereon may be positioned to allow the ink absorber member 11 to receive ink overspray beyond edges of the respective media. In an example, the upper plate surface 11 may also include a plurality of holes 29, for example, to allow air flow therethrough. For example, air flow generated by an air pump (not illustrated) through the holes 29 may suck the media to the upper plate surface 10b such as in a media loading stage and push the media away from the upper plate surface 10b such as in a media unloading stage.

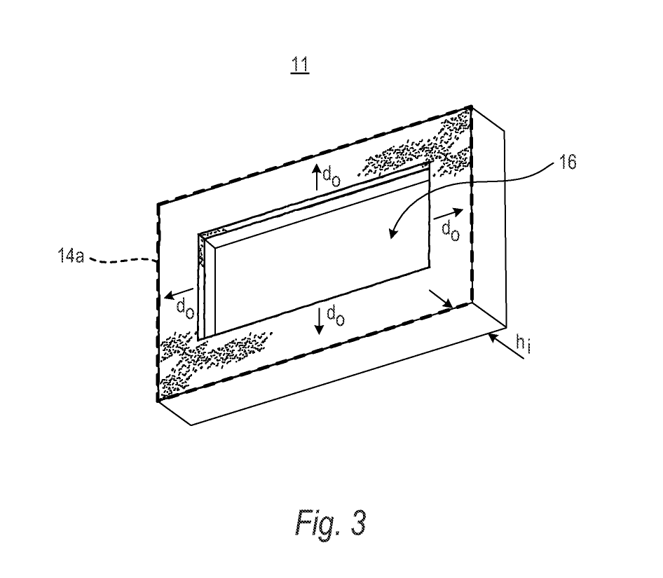

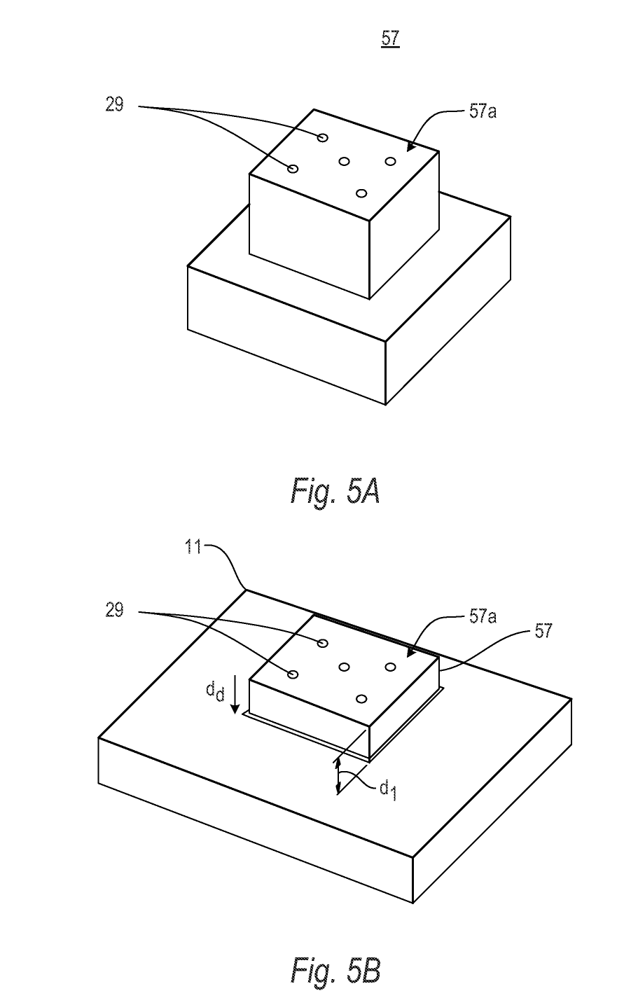

FIG. 3 is a perspective view illustrating an ink absorber member of an image forming apparatus according to an example. Referring to FIG. 3, in examples, an ink absorber member 11 may include a second exterior perimeter 14a and a receiver opening 16 to removably receive at least a portion of a plate receiver member 57 (FIG. 5A) extending therethrough. The receiver opening 16, for example, may have a shape to correspond with the shape of the plate receiving surface 57a (FIG. 5A) of the plate receiver member 57. For example, the shape of the receiver opening 16 and the plate receiving surface 57a may be a rectangle.

The ink absorber member 11 may surround at least a portion of the receiver opening 16 and extend in an outward direction dₒ therefrom. In the present example, the ink absorber member 11 may surround four sides of the rectangular-shaped receiver opening. The ink absorber member 11 may include reticulated foam. In the present example, the amount of pores of the reticulated foam may be in a range of twenty to thirty pores per inch and have a thickness hᵢ of approximately 10 millimeters.

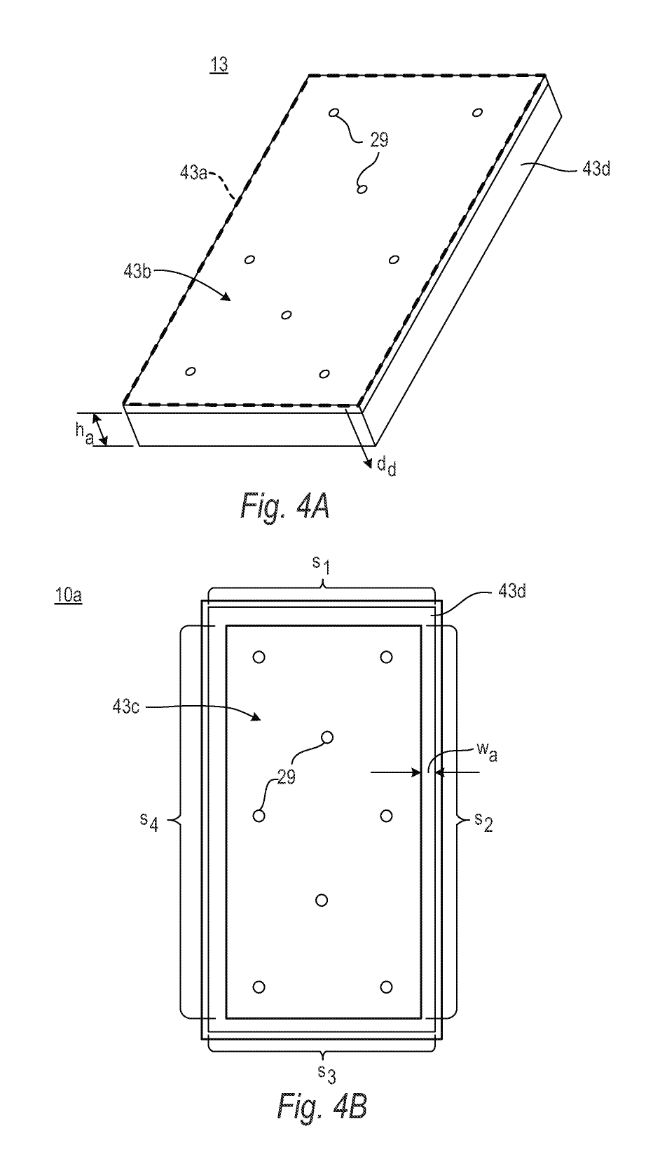

FIG. 4A is a perspective view illustrating a blotter unit of an image forming apparatus according to an example. FIG. 4B is a bottom view illustrating the blotter unit of FIG. 4A according to an example. Referring to FIGS. 4A and 4B, in examples, the blotter unit 13 may include a third exterior perimeter 43a, an upper blotter surface 43b, a lower blotter surface 43c, and a blotter member 43d. The upper blotter surface 43b may receive media on which to form images. In examples, a size and shape of the upper blotter surface 43b may correspond approximately to a size and shape of the media to be received. In the present example, the shape of the upper blotter surface 43b may be rectangular and the size of the upper blotter surface 43b may be slightly smaller than the media to be received to limit ink overspray from dribbling down the side of the plate member 10. For example, a respective media may extend beyond the upper blotter surface 43b by one eight of an inch on each side. That is, the blotter unit 13 and its upper blotter surface 43b may be 4.875 by 6.875 inches to receive a 5 by 7 inch media.

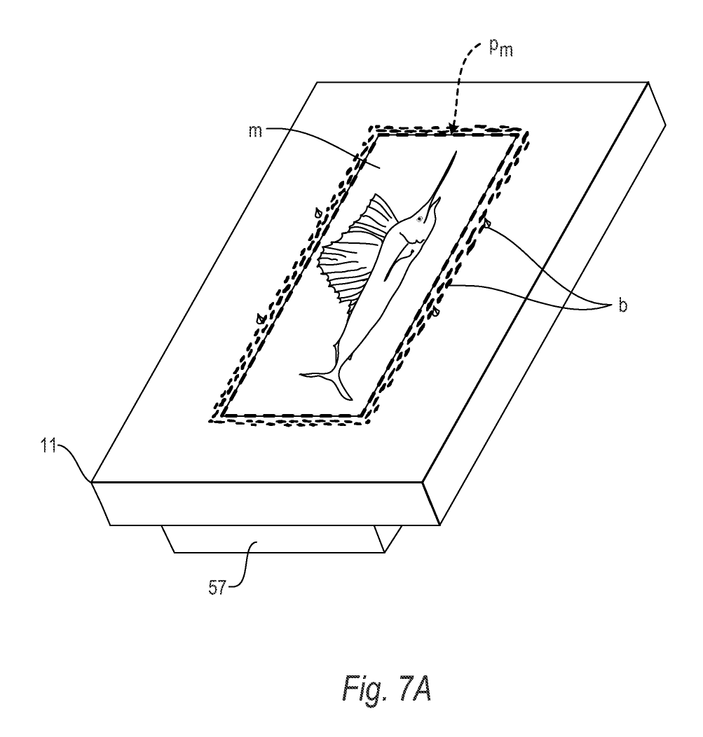

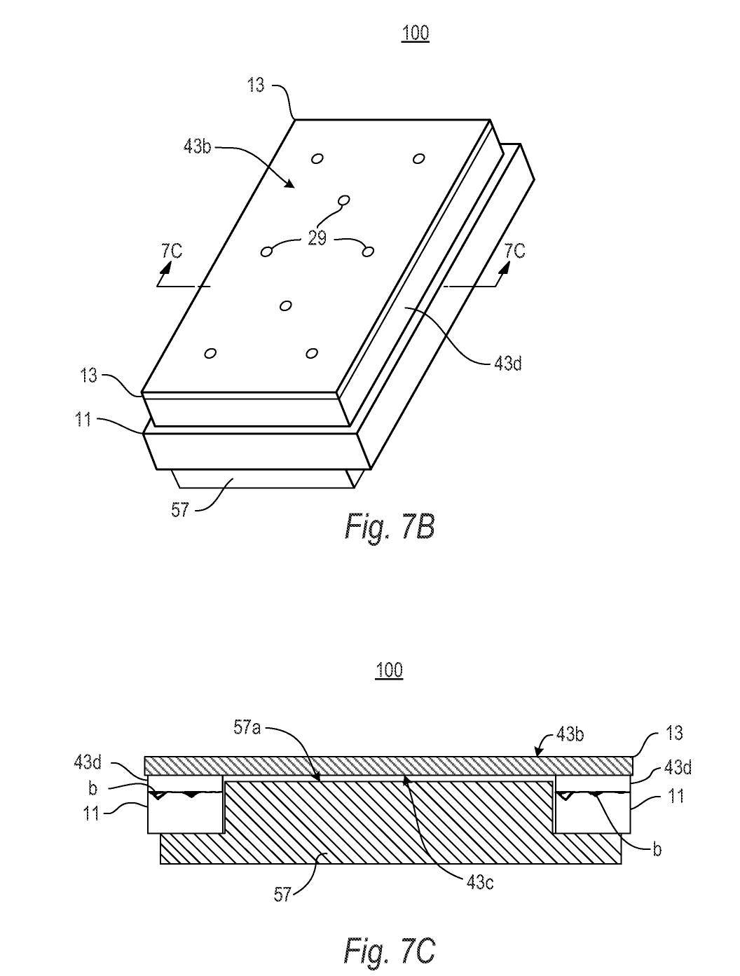

Referring to FIGS. 4A and 4B, in examples, the blotter member 44d may be disposed on the lower blotter surface 43c and extend in a downward direction d_{d} therefrom by a second distance d₂ (equal to a height of the blotter member hₐ) greater than a first distance d₁. The first distance d₁ may correspond to a distance in which a plate receiving surface 57a (FIG. 5B) may be disposed above the ink absorber member 11. The blotter member 13 may be of a size and shape to cover at least a portion of the ink absorber member 11 when pressed therein. For example, a size of the third perimeter 43a of the blotter unit 13 may be larger than a size of an exterior perimeter pₘ of the media (FIG. 7A) disposed on a respective plate member 10.

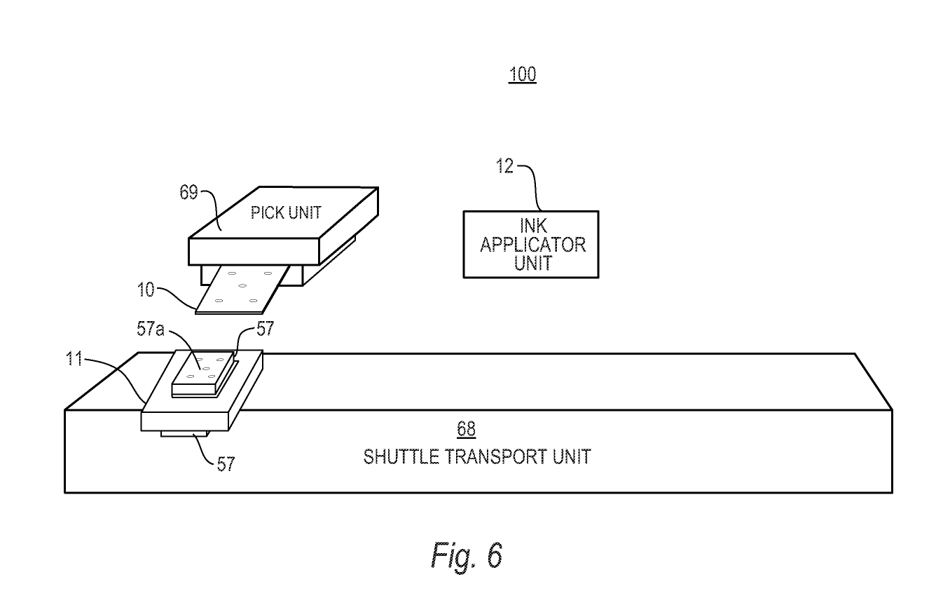

Accordingly, the blotter member 43d may be strategically placed on a lower blotter surface 43c of the blotter unit 13 to cover the respective area of ink build-up due to the overspraying of the smaller-size media. That is, ink build-up generally forms proximate to and outside the edges of the respective media. Thus, the blotter member 43d may periodically contact and press at least a portion of the ink build-up formed on the ink absorber member 11 therein. For example, a pick unit 69 (FIG. 6) may periodically move the blotter unit 13 towards the plate receiver member 57 (FIG. 7C) to press the blotter member 43d into the ink absorber member 11. That is, a pick unit 69 moves the lower blotter surface 43c of the blotter unit 13 towards the plate receiving surface 57a (FIG. 7C) such that the blotter member 43d contacts and presses at least a portion of the ink build-up formed on the ink absorber member 11 therein. Thus, a height of the ink build-up extending from the ink absorber member 11 may be reduced.

In the present example, the blotter member 43d may include a plurality of plastic sections s₁, s₂, s₃ and s₄ having a thickness hₐ and a width wₐ. In examples, the plastic sections s₁, s₂, s₃ and s₄ may be arranged adjacent to each other to form a surface area to correspond to at least a portion of a surface area of the ink absorber member 11. The blotter member surface may also include teflon, and the like, to reduce an amount of ink sticking thereto in response to contact with ink build-up on the ink absorber member 11. In examples, the upper blotter surface 43b may include a plurality of holes 29 to allow air flow therethrough, for example, to suck and/or push the media toward and/or away from the upper blotter surface 43b. The blotter unit 13 may periodically contact and press at least a portion of the ink build-up formed on the ink absorber member therein. Thus, a height of the ink build-up extending from the ink absorber member 11 may be reduced.

FIG. 5A is a perspective view illustrating a plate receiver member of an image forming apparatus according to an example. FIG. 5B is a perspective view illustrating the plate receiver member of FIG. 5A and the ink absorber member of FIG. 3A in an inserted state of an image forming apparatus according to an example. Referring to FIGS. 5A and 5B, in the present example, the image forming apparatus 100 may also include a plate receiver member 57. In the present example, the plate receiver member 57 may be removably inserted into the ink absorber member 11. The plate receiver member 57 may include a plate receiving surface 57a to receive the plate member 10. The plate receiving surface 57a may be disposed above the ink absorber member 11 by a first distance d₁. Accordingly, the ink absorber member 11 may be positioned below the plate receiving surface 57a by the first distance d₁. That is, the ink absorber member 11 is positioned in a downward direction d_{d} from the plate receiving surface 57a. Thus, the plate member 10, when loaded onto the plate receiving surface 57a, and the media, when loaded onto the plate member 10, are not in contact with the ink absorber member 11. In the present example, the first distance d₁ is in a range from two to three millimeters.

In examples, the plate receiver member 57 may move the plate member 10 received by the plate receiving surface 57a of the plate receiver member 57 between a plurality of stages such as a plate loading stage, a media loading stage, an ink deposition stage, a media unloading stage, and a plate unloading stage. For example, the plate receiver member 57 may be directly or indirectly connected to a shuttle transport unit 68 (FIG. 6) to move the plate member 10 received thereon between the respective stages. The plate loading stage may include loading the plate member 10 onto the plate receiving surface 57a of the plate receiver member 57. The media loading stage may include loading the media onto the upper plate surface 10b of the plate member 10. The ink deposition stage may include applying ink to the media disposed on the upper plate surface 10b of the plate member 10. The media unloading stage may include unloading the media from the upper plate surface 10b of the plate member 10. The plate unloading stage may include unloading the plate member 10 from the plate receiving surface 57a of the plate receiver member 57.

FIG. 6 is a schematic view illustrating a shuttle transport unit of an image forming apparatus according to an example. Referring to FIG. 6, in examples, the image forming apparatus 100 may also include a shuttle transport unit 68 to move the plate receiver member 57 between the plate loading stage, the media loading stage, the ink deposition stage, the media unloading stage, and the plate unloading stage. The shuttle transport unit 68 may include an endless belt or chain coupled to the plate receiver member 57 and configured to move the plate receiver member 57 along guides such as a rod, bar or support surface. In examples, the shuttle transport unit 68 may include a motor and screw mechanism, a motor and rack and pinion mechanism, a hydraulic or pneumatic piston-cylinder assembly, an electric solenoid or other mechanisms configured to linearly translate the plate receiver member 57, and the like.

Referring to FIG. 6, in examples, a pick unit 69 may sequentially load the plate members 10 on the upper plate surface 10b of the plate member 10. That is, the pick unit 69 transfers one plate member 10 at a time to the plate receiving surface 57a of the plate receiver member 57. For example, a subsequent plate member is not loaded to the plate receiving surface until a previously loaded plate member is removed therefrom. Additionally, the pick unit 69 may periodically move the blotter unit 13 towards the plate receiver member 57 to press the blotter member 43d into the ink absorber member 11. That is, the pick unit 69 moves the lower blotter surface 43c of the blotter unit 13 toward the plate receiving surface 57 such that the blotter member 13 contacts and presses at least a portion of the ink build-up formed on the ink absorber member 11 therein.

Thus, a height of the ink build-up extending from the ink absorber member 11 may be reduced. In examples, the pick unit 69 may also perform the media loading stage, the media unloading stage, and the plate unloading stage. That is, the pick unit 69 may load respective media onto the upper plate surface 10b of the respective plate members 10, unload the respective media from the upper plate surface 10b of the respective plate members 10, and sequentially unload the plate members 10 from the plate receiving surface 57a of the plate receiver member 57.

Referring to FIG. 6, in examples, the ink applicator unit 12 may apply ink onto the media to form images thereon and the ink absorber member 11 to form ink build-up thereon. For example, the ink applicator unit 11 may overspray ink directed to the media and an area beyond the media. For example, the area beyond the media may include an area around and proximate to edges of the media occupied by an ink absorber member 11. Such an area may correspond to an area on a different spatial plane than the respective media, outside the media edges and within the second exterior perimeter 14a of the ink absorber member 11.

FIG. 7A is a perspective view illustrating a plate member having media thereon, an ink absorber member, and a plate receiver member in a loaded state of an image forming apparatus according to an example. Referring to FIG. 7A, in an example, the plate member 10 having media m thereon having an exterior perimeter pₘ, an ink absorber member 11, and a plate receiver member 57 inserted into the ink absorber member 11 and in a loaded state is illustrated according to an example. An image is formed on the media m and ink build-up b is accumulated on the ink absorber member 11 due to an ink applicator unit 12 overspraying ink thereto. In the present example, the media m may be four by six inches.

FIG. 7B is a perspective view illustrating a blotter unit, an ink absorber member, and a plate receiver member in a loaded state of an image forming apparatus according to an example. FIG. 7C is a cross-sectional view taken along line 7C-7C of the blotter unit, the ink absorber member and the plate receiver member in the loaded state of FIG. 7B according to an example. Referring to FIGS. 7B and 7C, in an example, a blotter unit 10a and a plate receiver member 11 inserted into an ink absorber member 11 in a loaded state are illustrated. In the present example, the blotter unit 13 and the plate receiver member 57 are placed in the loaded state after the image was formed on the respective media m and the ink build-up b was formed on the ink absorber member 11. Accordingly, the blotter member 43d presses at least a portion of the ink build-up b on the ink absorber member 11 into the ink absorber member 11. In the present example, the blotter member 43d may depress the ink absorber member 11 by an amount in a range between a tenth of a millimeter and one millimeter.

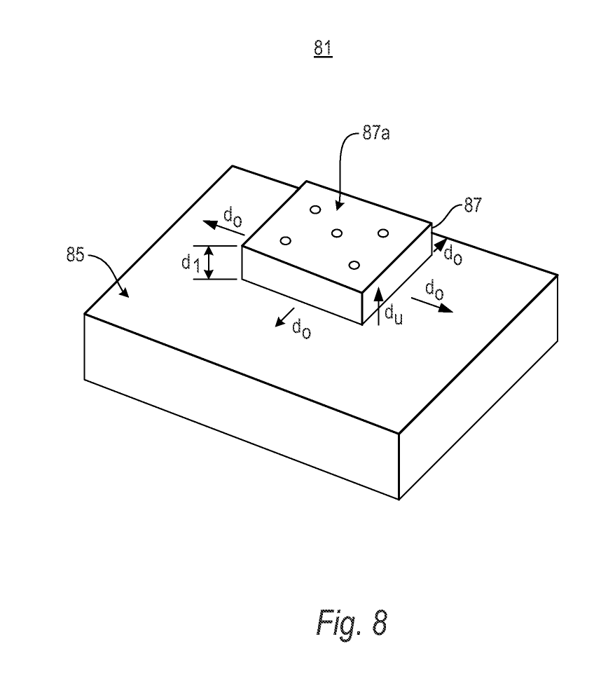

FIG. 8 is a perspective view of an ink absorber member of an image forming apparatus according to an example. Referring to FIG. 8, in examples, an ink absorber member 81 may include an absorber surface 85 and a plate receiver member 87. The absorber surface 85 may receive ink applied by an ink overspray from an ink applicator unit 12 (FIG. 6) to form ink build-up thereon. The plate receiver member 87 includes a plate receiving surface 87a to receive respective plate members 10 (FIG. 2) and extends in an upward direction dᵤ therefrom. The plate receiving surface 87a may be disposed above the absorber surface 85 by a first distance d₁. That is, the absorber surface 85 may be positioned below the plate receiving surface 87a by the first distance d₁.

Thus, the plate member 10 loaded onto the plate receiving surface 87a and the media loaded onto the plate member 10 are not in contact with the absorber surface 85. The absorber surface 85 may surround at least a portion of the plate receiver member 87 and extend in an outward direction dₒ therefrom. The ink absorber member 81 may move the plate member 10 received by the plate receiving surface 87a of the plate receiver member 87 between a plurality of stages. For example, the ink absorber member 81 may be directly or indirectly connected to the shuttle transport unit 68 previously disclosed with respect to FIG. 6.

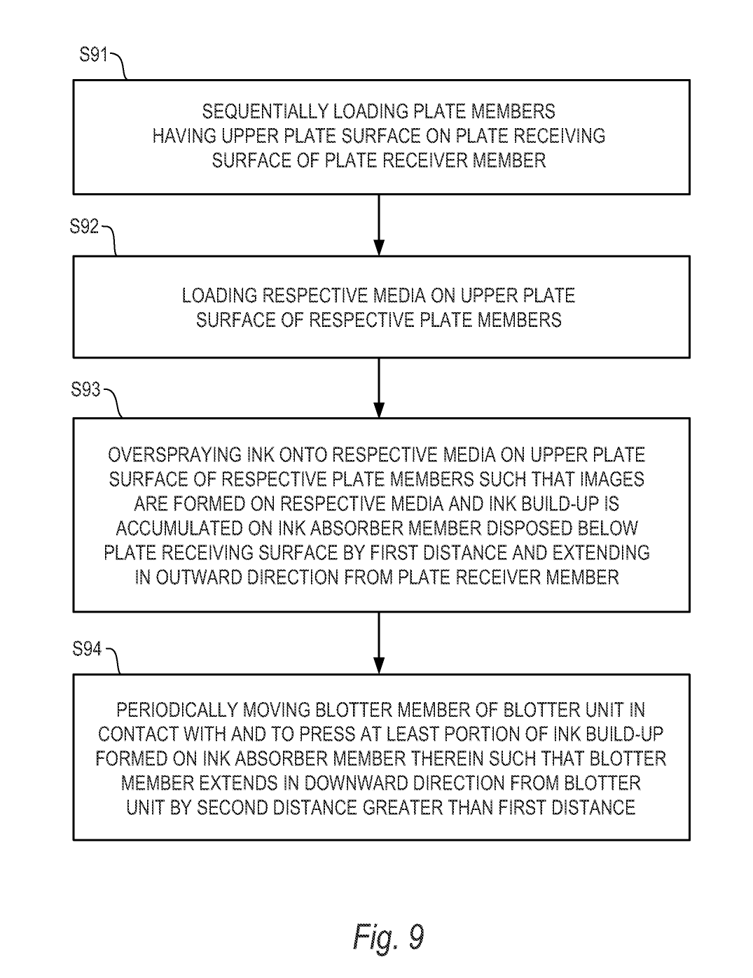

FIG. 9 is a flowchart illustrating a method of blotting ink build-up in image forming apparatus according to an example. Referring to FIG. 9, in block S91, plate members having an upper plate surface are sequentially loaded on a plate receiving surface of a plate receiver member. For example, the plate members may be sequentially loaded onto the plate receiving surface of the plate receiver member by a pick unit. That is, the pick unit may transfer one plate member at a time to the plate receiving surface of the plate receiver member. For example, a subsequent plate member is not loaded to the plate receiving surface until a previously loaded plate member is removed therefrom. In block S92, the upper plate surface of the respective plate members is loaded thereon with respective media. In block S93, the respective media on the upper plate surface of the respective plate members is oversprayed with ink such that images are formed on the respective media and ink build-up is accumulated on an ink absorber member disposed below the plate receiving surface by a first distance and extending in an outward direction from the plate receiver member.

In block S94, a blotter member of a blotter unit is periodically moved in contact with and to press at least a portion of the ink build-up formed on the ink absorber member therein such that the blotter member extends in a downward direction from a blotter unit by a second distance greater than the first distance. For example, the blotter member may move into contact with and to press at least a portion of the ink build-up formed on the ink absorber member by a pick unit. In examples, the blotter member may be periodically moved in contact with and to press at least a portion of the ink build-up by periodically moving a lower surface of the blotter member towards the plate receiving surface of the plate receiver member such that the blotter member presses into the ink absorber member by a predetermined depression amount.

The method may also include the plate receiver member being moved between a plurality of stages including at least one of a plate loading stage, a media loading stage, an ink deposition stage, a media unloading stage, and a plate unloading stage. The plate loading stage may include sequentially loading a respective plate member onto the plate receiving surface of the respective plate member. The media loading stage may include loading a respective media onto the upper plate surface of the respective plate member. The ink deposition stage may include applying ink to the respective media disposed on the upper plate surface of the respective plate member. The media unloading stage may include unloading the respective media from the upper plate surface of the respective plate member. The plate unloading stage may include sequentially unloading the respective plate member from the plate receiving surface of the plate receiver member.

It is to be understood that the flowchart of FIG. 9 illustrates an architecture, functionality, and operation of an example of the present disclosure. If embodied in software, each block may represent a module, segment, or portion of code that includes one or more executable instructions to implement the specified logical function(s). If embodied in hardware, each block may represent a circuit or a number of interconnected circuits to implement the specified logical function(s). Although the flowchart of FIG. 9 illustrates a specific order of execution, the order of execution may differ from that which is depicted. For example, the order of execution of two or more blocks may be scrambled relative to the order illustrated. Also, two or more blocks illustrated in succession in FIG. 9 may be executed concurrently or with partial concurrence. All such variations are within the scope of the present disclosure.

The present disclosure has been described using non-limiting detailed descriptions of examples thereof that are not intended to limit the scope of the present disclosure. It should be understood that features and/or operations described with respect to one example may be used with other examples and that not all examples have all of the features and/or operations illustrated in a particular figure or described with respect to one of the examples. Variations of examples described will occur to persons of the art. Furthermore, the terms “comprise,” “include,” “have” and their conjugates, shall mean, when used in the disclosure and/or claims, “including but not necessarily limited to.”

It is noted that some of the above described examples may include structure, acts or details of structures and acts that may not be essential to the present disclosure and which are described for illustrative purposes. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. An image forming apparatus, comprising:
a plate member including an upper plate surface to receive media on which to form images and a first exterior perimeter;
an ink absorber member including a second exterior perimeter and an ink absorber member;
an ink applicator unit to apply ink onto the media to form images thereon and the ink absorber member to form ink build-up thereon; and
a blotter unit to periodically contact and press at least a portion of the ink build-up formed on the ink absorber member therein.

2. The image forming apparatus according to claim 1, further comprising:
a plate receiver member including a plate receiving surface to receive the plate member, the plate receiving surface disposed above the ink absorber member by a first distance.

3. The image forming apparatus according to 2, wherein the plate receiver member is coupled to and extends in an upward direction from the ink absorber member.

4. The image forming apparatus according to claim 3, wherein the ink absorber member moves the plate member received by the plate receiving surface of the plate receiver member between a plurality of stages.

5. The image forming apparatus according to 2, wherein the ink absorber member further comprising:
a receiver opening to removably receive at least a portion of the plate receiver member extending therethrough.

6. The image forming apparatus according to claim 5, wherein the plate receiver member moves the plate member received by the plate receiving surface of the plate receiver member between a plurality of stages.

7. The image forming apparatus according to claim 6, wherein the plurality of stages include at least one of a plate loading stage to load the plate member onto the plate receiving surface of the plate receiver member, a media loading stage to load the media onto the upper plate surface of the plate member, an ink deposition stage to apply ink to the media disposed on the upper plate surface of the plate member, a media unloading stage to unload the media from the upper plate surface of the plate member, and a plate unloading stage to unload the plate member from the plate receiving surface of the plate receiver member.

8. The image forming apparatus according to claim 2, wherein the blotter unit further comprises:
a lower blotter surface; and
a blotter member disposed on the lower blotter surface and extending in a downward direction therefrom by a second distance greater than the first distance, the blotter member to periodically contact and press at least a portion of the ink build-up formed on the ink absorber member therein.

9. The image forming apparatus according to claim 8, wherein the blotter unit further comprises:
an upper blotter surface to receive media on which to form images.

10. The image forming apparatus according to claim 8, wherein the second exterior perimeter is greater than the first exterior perimeter.

11. The image forming apparatus according to claim 10, wherein the upper blotter surface of the blotter member receives respective media having a first size and the upper plate surface of the plate member receives respective media having a second size which is smaller than the first size.

12. The image forming apparatus according to claim 3, wherein the ink absorber member surrounds at least a portion of the plate receiver member and extends in an outward direction therefrom.

13. The image forming apparatus according to claim 5, wherein the ink absorber member surrounds at least a portion of the receiver opening and extends in an outward direction therefrom.

14. The image forming apparatus according to claim 2, further comprising:
a plurality of plate members to receive media of a predetermined size such that each plate member receives a different-size media.

15. The image forming apparatus according to claim 14, further comprising:
a pick unit configured to sequentially load the respective plate members on the plate receiving surface of the plate receiver member and periodically place the blotter member in contact with and to press at least a portion of the ink build-up formed on the ink absorber member therein.

16. The image forming apparatus according to claim 15, wherein the pick unit also loads respective media onto the upper plate surface of the respective plate members, unloads the respective media from the upper plate surface of the respective plate members, and sequentially unloads the plate members from the plate receiving surface of the plate receiver member.

17. An image forming apparatus, comprising:
a plate member including an upper plate surface to receive media on which to form images and a first exterior perimeter;
an ink absorber member including a second exterior perimeter, the second exterior perimeter is greater than the first exterior perimeter;
a plate receiver member including a plate receiving surface to receive the plate member, the plate receiving surface disposed above the ink absorber member by a first distance;
an ink applicator unit to apply ink onto the media to form images thereon and the ink absorber member to form ink build-up thereon; and
a blotter unit including an upper blotter surface, a lower blotter surface, and a blotter member;
the upper blotter surface to receive media on which to form images; and
the blotter member disposed on the lower blotter surface and extending in a downward direction therefrom by a second distance greater than the first distance, the blotter member to periodically contact and press at least a portion of the ink build-up formed on the ink absorber member therein.

18. A method of blotting ink build-up in an image forming apparatus, the method comprising:
sequentially loading plate members having an upper plate surface on a plate receiving surface of a plate receiver member;
loading respective media on the upper plate surface of the respective plate members;
overspraying ink onto the respective media on the upper plate surface of the respective plate members such that images are formed on the respective media and ink build-up is accumulated on an ink absorber member disposed below the plate receiving surface by a first distance and extending in an outward direction from the plate receiver member; and
periodically moving a blotter member of a blotter unit in contact with and to press at least a portion of the ink build-up formed on the ink absorber member therein such that the blotter member extends in a downward direction from a blotter unit by a second distance greater than the first distance.

19. The method according to claim 18, wherein periodically moving a blotter member in contact with and to press at least a portion of the ink build-up comprises:
periodically moving a lower surface of the blotter member towards the plate receiving surface of the plate receiver member such that the blotter member presses into the ink absorber member by a predetermined depression amount.

20. The method according to claim 18, further comprising:
moving the plate receiver member between a plurality of stages including at least one of a plate loading stage to sequentially load a respective plate member onto the plate receiving surface of the respective plate member, a media loading stage to load a respective media onto the upper plate surface of the respective plate member, an ink deposition stage to apply ink to the respective media disposed on the upper plate surface of the respective plate member, a media unloading stage to unload the respective media from the upper plate surface of the respective plate member, and a plate unloading stage to sequentially unload the respective plate member from the plate receiving surface of the plate receiver member.
